(19) United States
(12) Patent Application Publication
(10) Pub. No.: US 2026/0077728 A1
(43) Pub. Date: Mar. 19, 2026

(54) Vehicle Power Management System and Method for Creating and Using a Current Draw Profile to Assess Whether a Load Is an Authorized Part

(71) Applicant: Knorr-Bremse AG, Munich (DE)

(72) Inventors: Thomas J. Hayes, Lakewood, OH (US); David Kiss, Szar (HU); Daniel P. Zula, North Ridgeville, OH (US); Peter Lindner, Rackeve (HU); David Scuito, Molalla, OR (US)

(73) Assignee: Knorr-Bremse AG, Munich (DE)

(21) Appl. No.: 18/885,030

(22) Filed: Sep. 13, 2024

(51) Int. Cl. B60R 16/03

(52) U.S. Cl. CPC B60R 16/03

(57) ABSTRACT

A vehicle power management system and method are provided for creating and using a current draw profile to assess whether a load is an authorized part. In one embodiment, a vehicle power management system is provided comprising circuitry configured to: monitor a current draw from a load; determine if the monitored current draw matches an expected current draw; and in response to determining that the monitored current draw does not match the expected current draw, flag the load is an unexpected load. Other embodiments are provided.

### BACKGROUND

A vehicle is typically manufactured with parts sourced from an original equipment manufacturer (OEM) or its authorized supplier (e.g., a Tier 1 supplier). Over time, one or more of these parts may need to be replaced by the owner of the vehicle.

Instead of using a genuine replacement part from the OEM or its authorized supplier, the owner of the vehicle may use a replacement part from an unauthorized supplier. An authorized replacement part may not be up to the standards set by the OEM and, as a result, can create undesirable conditions in the vehicle.

### BRIEF DESCRIPTION OF THE DRAWINGS

FIG. 1 is a diagram of a power management system of an embodiment.

FIG. 2 is a flow chart of a method of an embodiment for determining, based on current draw, whether a load is an authorized part.

FIG. 3 is a flow chart of a method of an embodiment for learning a current profile of an electrical load after nominal vehicle use.

FIG. 4 is a flow chart of a method of an embodiment for learning a current profile of an electrical load after an original load is replaced or a new system is composed.

FIG. 5 is a diagram of a switching circuit of an embodiment.

### SUMMARY

In one embodiment, a vehicle power management system is provided comprising: an input configured to receive current from a power source in a vehicle; one or more outputs configured to couple with a respective one or more loads of the vehicle; one or more switches associated with the respective one or more outputs, wherein each switch is configured to selectively open and close to selectively provide current received from the power source to that switch's associated output; and circuitry configured to: monitor a current draw from a load of the one or more loads; determine if the monitored current draw matches an expected current draw; and in response to determining that the monitored current draw does not match the expected current draw, flag the load is an unexpected load.

In another embodiment, a method is provided that is performed in a vehicle. The method comprises: creating a current profile for a load of the vehicle by monitoring current draws from the load and conditions of the vehicle when the current draws occurred; monitoring a current draw from a replacement load; determining if the monitored current draw of the replacement load matches the current profile; and in response to determining that the monitored current draw does not match the current profile, flagging the replacement load as being unauthorized.

In yet another embodiment, a vehicle power management system is provided comprising: an input configured to receive power from a power source in a vehicle; an output configured to couple with a load of the vehicle; and circuitry configured to: determine whether an expected current draw of the load has changed; in response to determining that the expected current draw of the load has changed, update a current profile for the load; monitor a current draw from the load; determine if the monitored current draw matches the updated current profile; and in response to determining that the monitored current draw does not match the updated current profile, flag the load as being unauthorized.

Other embodiments are possible, and each of the embodiments can be used alone or together in combination.

### DETAILED DESCRIPTION

### Introduction

As mentioned above, a vehicle is typically manufactured with parts (sometimes referred to herein as “loads”) sourced from an original equipment manufacturer (OEM) or its authorized supplier (e.g., a Tier 1 supplier). Over time, one or more of these parts may need to be replaced by the owner of the vehicle. Instead of using a genuine replacement part from the OEM or its authorized supplier, the owner of the vehicle may use a replacement part from an unauthorized supplier. An authorized replacement part may not be up to the standards set by the OEM and, as a result, can undesirable conditions in the vehicle.

In the following embodiments, a power management system in a vehicle can be used to detect whether a load in the vehicle is an authorized/correct part by comparing the current draw of the load with an expected current draw (e.g., current profile) associated with an authorized/correct part. If the current draw does not match (e.g., within some degree of tolerance) the expected current drawn, the system can conclude that an unauthorized/incorrect part is being used and take an action to flag the situation, such as informing a vehicle controller associated with the load, informing fleet management, degrading performance of the unauthorized/incorrect part, etc. The power management system can be made aware of the expected current draw by being provided with an expected current profile and/or the power management system can be configured to learn the expected current profile after nominal vehicle use, after a component is replaced, and/or after a new system is composed.

The following sections describe example implementations of these embodiments. It should be understood that these are merely examples and that other implementations can be used. As such, the details presented herein should not be read into the claims unless expressly recited therein.

### Overview of an Example Vehicle/Power Management System

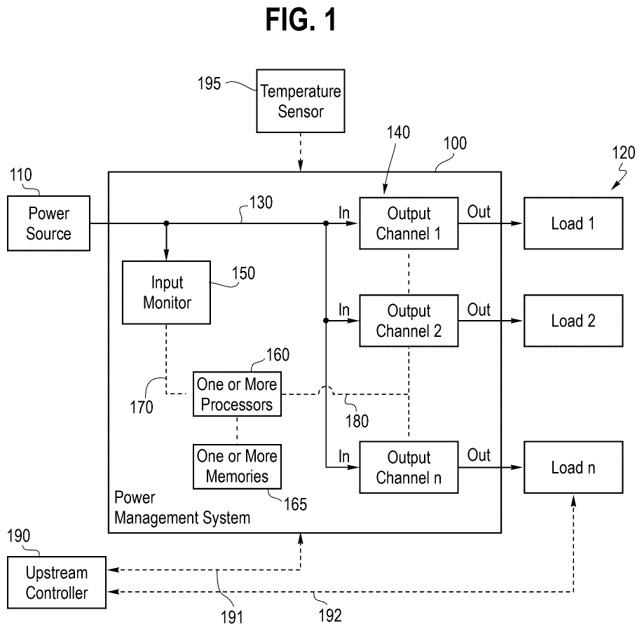

Turning now to the drawings, FIG. 1 is an illustration of an example vehicle of an embodiment. The vehicle can take any suitable form, such as, but not limited to, a car, a truck, a tractor capable of towing a trailer, a passenger automobile, etc., and can be an electric vehicle, a vehicle with an internal combustion engine, or a hybrid vehicle.

The below claims should not be limited to a specific type of vehicle unless expressly recited therein. Furthermore, the terminology used herein is intended to apply to any type of vehicle.

As shown in FIG. 1, in this embodiment, the vehicle comprises a power management system 100, a power source 110, and one or more (here, a plurality of) loads 120 (Load 1, Load 2, . . . Load N). The power source 110 can take any suitable form, such as, but not limited to, a battery, an alternator, a DC-DC converter (e.g., a 48V-to-24V or 12V converter), etc. Also, the loads 120 can take any suitable form, such as, but not limited to, a starter, vehicle sensors, pumps, compressors, braking controllers, engine controllers, a climate system (e.g., air/heat), an entertainment system (e.g., radio/audio, video, etc.), a navigation system, power seats, windshield wipers, etc.

The power management system 100 and the plurality of loads 120 are in communication with an upstream controller 190. While one upstream controller 190 is shown in the example of FIG. 1, it should be understood that multiple controllers on the same vehicle network communication line can be used. Also, a temperature sensor 195 (e.g., configured to sense an ambient temperature of the vehicle) is in communication with the power management system 100. Other components of the vehicle are not shown in FIG. 1 to simply the drawing. Also, when the vehicle takes the form of a tractor-trailer, some or all of the components can be placed in the tractor and/or the trailer.

In this example, the power management system 100 comprises an input monitor 150, one or more processors 160, and one or more memories 165, and one or more (here, a plurality of) output channels 140 (Output Channel 1, Output Channel 2, . . . Output Channel n). In another embodiment, a single output channel is used. The input monitor 150 and the plurality of output channels 140 are coupled with the power source 110 via a power line 130, and the input monitor 150 and the plurality of output channels 140 are respectively coupled with the one or more processors 160 via (wired or wireless) electrical connections 170 and 180, which, in one embodiment, are communication channels (e.g., a communications area network (CAN) channel or a direct, point-to-point communication channel, such as a universal asynchronous receiver-transmitter (UART) link. In another embodiment, the electrical connections 170 and 180 are direct electrical connections that transmit analog or digital voltage. Also, while CAN is used in this example, it should be understood that any kind of communication method for the vehicle (e.g., CAN, Ethernet, PLC, WiFi, etc.) can be used.

The input monitor 150 can take the form of a sensor that is configured to read the power (or voltage or current) on the power line 130 from the power source 110. Other types of sensors that detect other types of conditions can be used.

The one or more processors 160 are configured to execute computer-readable program code having instructions (e.g., modules, routines, sub-routine, programs, applications, etc.) that, when executed by the one or more processors, individually or in combination, cause the one or more processors to perform the functions described herein (and, optionally, other functions). The computer-readable program code can be stored in the one or more non-transitory computer-readable storage medium (memories) 165, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. Alternatively, a purely-hardware implementation (e.g., an application-specific integrated circuit (ASIC)) can be used. The term “circuitry” will be used herein to broadly refer to any appropriate decision-making device, such as, but not limited to, a processor, a microprocessor, an ASIC, an analog circuit, etc.

In this embodiment, each output channel comprises a solid-state switch (or relay) that is configured to selectively open and close to disconnect and connect, respectively, the power source 110 from/to the output channel's load in response to a control signal provided by the one or more processors 160 via communication channel 180. Such as switch is sometimes referred to herein as a “smart fuse,” which is different from a conventional mechanical-contactor or thermal-melting fuse that automatically opens in the event of fault. A more-detailed example of one specific implementation of an output channel is provided later in this document.

### Using a Current Draw Profile to Assess Whether a Load is Authorized

As mentioned above, in one embodiment, the power management system 100 is configured to use a current draw profile to assess whether a load is authorized. In other embodiment, a different component in the vehicle is used to perform this function. In general, each output channel of the power management system 100 can learn the normal operating conditions of its downstream load and alert the vehicle of a significant variance due to wear over time or use of a non-approved replacement part. The power management system 100 can also compensate its measurements based on ambient temperature.

In one example implementation, the one or more processors 160 in the power management system can, individually or in combination, be configured to monitor a current draw from a load and determine if the monitored current draw matches an expected current draw. The monitored current draw and the expected current draw can “match” if they match exactly or match within some a degree of tolerance (e.g., to account for normal wear-and-tear or installation differences such as wire lengths or component locations). If the monitored current draw and the expected current draw do not match, the one or more processors 160 can flag the load as an unexpected load. Also, the expected current draw can be a baseline current draw or be from a library of expected current draws, which can be provided by a manufacturer of the vehicle or built by the one or more processors 160. The following section provide more information on how the one or more processors 160 can build a current profile.

“Flagging the load as an unexpected load” broadly refers to any action directly or indirectly caused by the one or more processors 160 to provide an indication that the load is not an unexpected load, which can imply that the load is not an authorized part or that the load (authorized or not) is not the correct part. For example, in environments in which the load is associated with its own controller (an electronic controller unit “ECU”), flagging the load as an unexpected load can mean informing the controller, which can be configured to simply log the information or take some action with respect to the operation of the part. As another example, flagging the load as an unexpected load can mean informing the OEM or fleet management that the load is an unauthorized part. This can involve the one or more processors 160 providing an instruction to the upstream controller 190 to transmit the message over a wired or wireless network. Alternatively, the power management system 100 can transmit the message if it has such capability. Flagging the unexpected load as an unexpected load can also mean informing the driver of the vehicle (e.g., by the upstream controller 190 providing a message on a dashboard display) that the part is unauthorized/incorrect, that the part should be replaced, and/or that the existing part will encounter reduced performance, for example. As yet another example, an expected load can comprise a dynamic load signature that may vary in time, phase, and/or use case.

The one or more processors 160 can take other actions in response to determining that the monitored current draw does not match the expected current draw.

For example, if the monitored current draw matches a current profile of a known third-party load, the one or more processors 160 can reduce service time of the load. More generally, the one or more processors 160 can limit a function of the load (e.g., after provide the driver with advance warning).

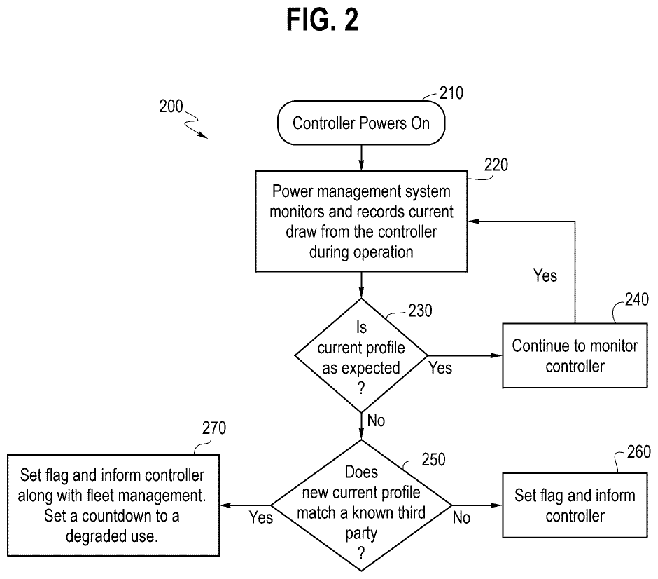

Turning again to the drawings, FIG. 2 is a flow chart 200 of example method of an embodiment. This is only an example, and the details presented herein should not be read into the claims unless expressly recited therein. In this example, a controller (e.g., an ECU) is associated with and controls a load in the vehicle. As shown in FIG. 2, after that controller powers on (210), the power management system 100 monitors and records the current draw from the controller (which provides the current to the load) (220). The power management system 100 then determines if the current profile is expected (230). If the current profile is as expected, the power management system 100 continues to monitor the current draw of the controller (240). However, if the current profile is not as expected, the power management system 100 determines if the current profile matches a known third party (250). If it doesn't, the power management system 100 sets a flag and informs the controller (260). If it does, the power management system 100 sets a flag and informs the controller along with fleet management and sets a countdown to degraded use (270).

In summary, as noted above, when a vehicle is built from the OEM, it will typically use OEM or Tier 1 supplier parts for the build. These will have a specific current draw when they are used by the driver or the vehicle system. As these parts are replaced, owners may use third-party parts to replace used OEM parts, which may result in a change in baseline performance. As these parts are different from the OEM parts, the current draw profile will be different. In addition, some systems may have a specific component inside, which changes the current profile without any change in function. These components can be changed at a time interval to ensure a third party is not able to counteract this method of determining OEM parts. A power distribution system with current measurement can be able to measure these load profiles and, with additional CAN information or vehicle function (e.g., a chuff test), can determine if, for a certain defined action, the current measurement is different than the baseline part it was installed with. If the system determines the newly-installed part is not a genuine OEM part, either by comparing it to the baseline or comparing it to a known library of third-party parts, it can send a message to the OEM or fleet that a non-approved part is being used. The system can also reduce the service time of the part due to less confidence in its function or change the performance of the system by limiting off that function after an advanced warning.

There are several advantages associated with these embodiments. For example, these embodiments can be used to solve concerns about the use of third-party parts in OEM applications that may cause a lack of proper performance when compared to the base system. This can ensure that the OEM retains a larger portion of maintenance costs. As a secondary function, the system can also determine if an incorrect voltage part is installed on the vehicle (e.g., 12V vs. 24V), as these can exhibit a current draw that is different than the baseline. The power monitoring and distribution system can use high-precision current monitoring for every system it is connected to, in addition to a communication method to communicate to the vehicle network.

This style of power monitoring is not commonplace in production vehicles today, and this provides a new way to determine the types of parts used by the vehicle system without the need for a human to inspect them. This system can measure and compare the current profiles for all types of vehicle electrical loads, such as, but not limited to valves (solenoids), electronics (sensors), and motors (drivetrain and steering). It can also determine if an incorrect part is installed, minimizing the chance of technician error due to taking a wrong part from the parts bin.

The power monitoring system, along with the load controller it is monitoring, can be assembled at the OEM. The monitoring system can know the current draw from the load controller in various actions and can either build an internal database based on collected information or be programmed with this information from the manufacturer. If the current monitoring detects a change in the draw of the system that is not associated with possible wear of the system, it can set a flag and inform the load controller and also inform the fleet manager. This can be detected when the system performs a chuff test or other startup tests. As an additional step, the monitoring system can have a built-in database of known third-party parts used in the application and can compare the measured current draw to the known current draw. If they are a match, the system can set another flag that a confirmed third-party part is being used on the vehicle and, once again, inform the load controller and the fleet manager.

### Learning a Current Draw Profile After Nominal Vehicle Use

As mentioned above, the power management system 100 can be made aware of the expected current draw by being provided with an expected current profile and/or the power management system 100 can be configured to learn the expected current profile. For example, the power management system 100 can be configured to learn the expected current profile after nominal vehicle use. In one example implementation, the power management system 100 creates a current profile for a load of the vehicle by monitoring current draws from the load and conditions of the vehicle when the current draws occurred, monitors a current draw from a replacement load, determines if the monitored current draw of the replacement load matches the current profile, and in response to determining that the monitored current draw does not match the current profile, flags the replacement load as being unauthorized.

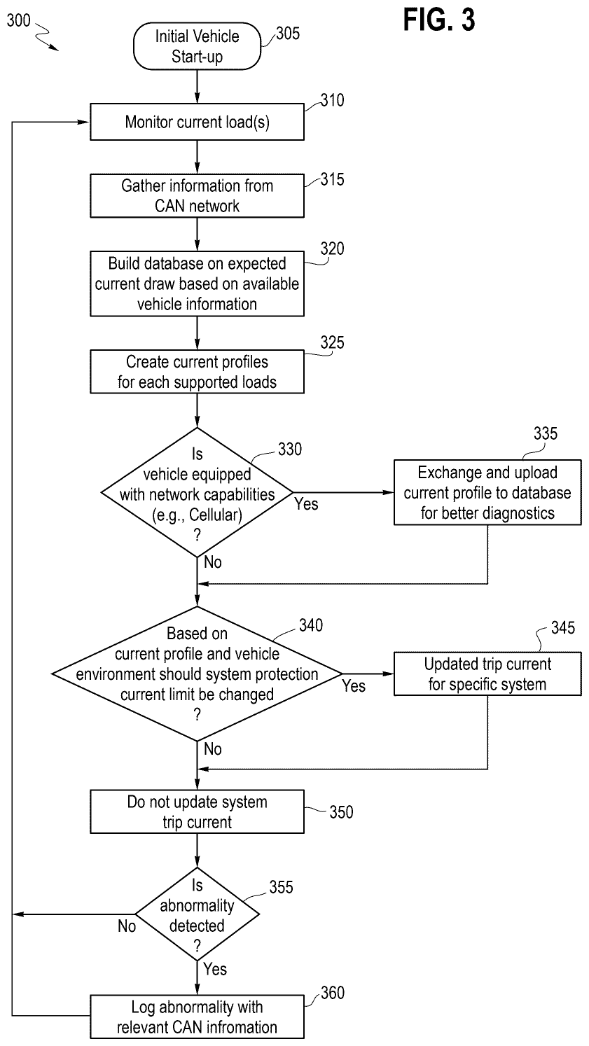

Turning again to the drawings, FIG. 3 is a flow chart 300 of example method of an embodiment. This is only an example, and the details presented herein should not be read into the claims unless expressly recited therein. As shown in FIG. 3, after initial vehicle starting (305), the power management system 100 monitors current load(s) (310) and gathers information from the CAN network (315). This information can include, but is not limited to, air pressure information, ambient temperature, value or other system actuations, system voltage, and/or diagnostic information. The power management system 100 then builds a database of expected current draw based on available vehicle information (320) and creates a current profile for each load (325). The power management system 100 then determines if the vehicle is equipped with network capabilities (330). If it is, the power management system 100 can exchange and upload the current profiles to a database for better diagnostics (335).

Next, the power management system 100, based on the current profile and vehicle environment, determines whether the system protection current limit should be changed (340). If it should be changed, the power management system 100 updates the trip current for the specific system (345). Otherwise, the system trip current is not updated (350). Either way, the power management system 100 then determines if an abnormality is detected (355), and, if it is, logs the abnormality with the relevant CAN information (360).

In summary, vehicles equipped with a current and power distribution system can closely monitor the current drawn by the systems it supports. Using this monitoring and knowledge of the vehicle state, battery voltage, operating environment, vehicle pressure, etc., a highly-defined current profile can be created for every system attached to the power distribution system. This profile can then be shared to other vehicles (e.g., if those vehicles are connected to a cloud server). As this profile is created, the trip currents for the support system may become dynamic and can be changed depending on the vehicle's operating environment. It may also be determined that a current supply with a lower power rating can be used for that specific system.

The data gathered during the lifetime of the electrical load can be used to optimize the next generation of such electrical loads either by changing the hardware or just by updating the software. For example, at low temperatures, the inrush current of one of the loads can have a significant impact on the battery life, and the next generation can include a pre-charge circuit that can increase the battery lifetime. Depending on the environment of operation of an electrical or mechatronic device, the current draw of the equipment can change. Due to every vehicle operating in a very different environment and using the equipment in a different manner, each power distribution module can create a custom current profile for each vehicle. It can also map these profiles to drivers and routes to determine if excessive use is occurring on these routes or by these drivers, adding in better planning to ensure parts last longer. Using a smart current profile along with a smart current disconnect (as opposed to traditional melting fuses) can allow for better protection and less driver nuisance for melting fuses not performing correctly. The power distribution and monitoring system can have a connection to the vehicle CAN to receive information on the vehicle state, such as pressures, temperatures, speeds, and actions exercised on the monitored device. The system can also correlate the actions of the monitored systems to the reactions from the vehicle. Such as the change of an “AIR1” J1939 message in relation to the activation of pneumatic valves, showing a correct drop in pressure supply if the compressor is turned off. All of these reactions can create a datapoint to refer to in a future case if the “AIR1” pressure reaction changes compared to a known action. This monitoring system can also allow for better diagnostics of a certain part. For example, it can determine if a part was faulty at a certain extreme temperature but is working fine when at an ambient temperature, or if the current draw is correct but the resulting change in air pressure is different. This can result in fewer parts returned with no faults found during investigation, thus reducing inconvenient for the fleet manager. While the vehicle is in an operating state, the power distribution and monitoring system can monitor the current draw from its monitored systems and compare it with CAN information it receives from the vehicle network. For all types of different operating environments, the system can build a database for the current draw of that system in those specific conditions and any reactions from the vehicle (e.g., air pressure changes, voltage changes, etc.). It can continue to build this database for the life of the parts it is monitoring, alerting a fleet manager of any deviations, along with the operating conditions present when the deviation occurred. As the database of current profiles is created and updated, the monitoring system can update trip or protection currents as it knows more about the system, including dynamic changes based on the vehicle operating environment, temperatures, and system voltage. If the part is replaced after use, it can determine if the new part is aging the same way.

### Learning a Current Draw Profile After a Component is Replaced or After a New System is Composed

As mentioned above, the power management system 100 can be also be configured to learn the expected current profile after a component is replaced, and/or after a new system is composed. In one example implementation, the power management system 100 can determine whether an expected current draw of a load has changed; in response to determining that the expected current draw of the load has changed, update a current profile for the load; monitor a current draw from the load; determine if the monitored current draw matches the updated current profile; and in response to determining that the monitored current draw does not match the updated current profile, flagging the replacement load as being unauthorized.

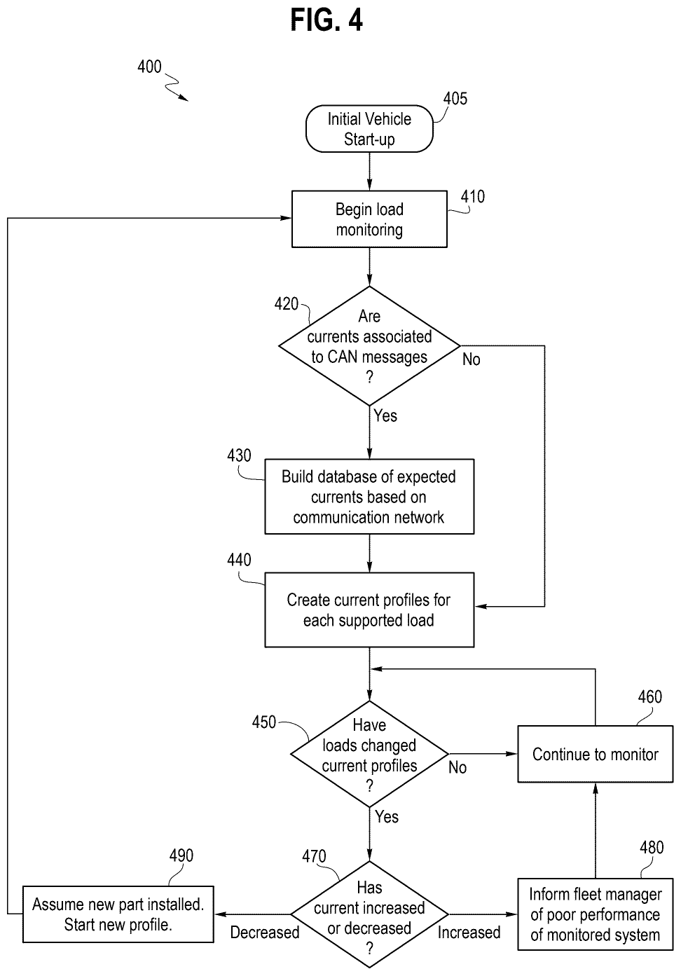

Turning again to the drawings, FIG. 4 is a flow chart 400 of example method of an embodiment. This is only an example, and the details presented herein should not be read into the claims unless expressly recited therein. As shown in FIG. 4, after vehicle start-up (405), the power management system 100 begins load monitoring (410) and determines whether currents are associated with CAN messages (420). If they are, the power management system 100 builds a database of expected currents based on the communication network (430). Otherwise, the power management system 100 creates current profiles for each supported load (440). Next, the power management system 100 determines if loads have changed their current profiles (450). If they haven't, the power management system 100 continues monitoring (460) and informs the fleet manager of poor performance of the monitored system (470). Otherwise, the power management system 100 determines if the current increased or decreased (480). If the current increased, the power management system 100 informs the fleet manager of poor performance of the monitored system (470). If the current decreased, the power management system 100 assumes a new part is installed and starts a new profile 480).

In summary, the power management system 100 can monitor and log the current consumed by the loads it supports. Using this logging, the power management system 100 can create an electrical profile for loads. When a vehicle is built and it does not know what loads are connected or when a load is replaced due to wear, the power management system 100 can learn the new current draw pattern and detect if the current profile is reaching a replacement trigger. When new components are used during OEM assembly of a new vehicle, the electrical loads are not always known and can be learned by the power management system 100. This also includes when a component is replaced with a new part during vehicle maintenance. This profile learning can allow the power management system 100 to compare measured current values against known activities, such as brake activation, normal operation, driver requests, etc.

Knowing these current draws can allow the power management system 100 to better monitor the loads it is attached to for proper response to inputs, based on vehicle CAN messages. It can also confirm if a part has been replaced due to a change in current draw (e.g., from an older current draw to a new current draw), which can be used by fleets to confirm proper maintenance on the vehicle. When a vehicle is built, and no current profiles are associated with the vehicle, the power management system 100 can learn these profiles but monitoring CAN activity and correlating the current draw of the load it is monitoring. This can allow the power management system 100 to associate functions to specific current values. After the vehicle is built, the power management system 100 can perform tests to gain a baseline of the current draws and its effects on the vehicle. Before the vehicle is delivered to a customer, actions can be performed, such as chuff tests, external braking or control requests, power up and shut down of devices, human requests, etc., all while monitoring the current draw(s) of the different system and the information available on the vehicle network (e.g., air pressure, supply voltage, braking requests, ABS, brake pedal activation, etc.) to create an initial profile of the system(s) it supports. Over time, these current draws can increase as internal resistances grow by device use. If the current draw drops after a maintenance period, this can trigger the power management system 100 to start a new monitoring profile as the part was replaced, and the power management system 100 may not know if it was replaced with the same part. This can allow for confirming that maintenance was performed and determining faulty parts if the current associated with a known function changes suddenly.

When an initial power up of an OEM vehicle is done and there are no associated current profiles, the power management system 100 can start monitoring each of the outputs it has. Based on CAN or other communications, the power management system 100 can determine which loads are connected where, if not already programmed, and build a table for current draws based on the actions on the CAN. Before the vehicle is delivered, as many tests as possible can be performed to give as much information as possible to the power management system 100. As the vehicle is used, more information is collected. The power management system 100 can then determine if a part is replaced based on the current draw of that individual part. If a part is replaced, the power management system 100 can start a new data collection and start the process over again.

### Output Channel Example

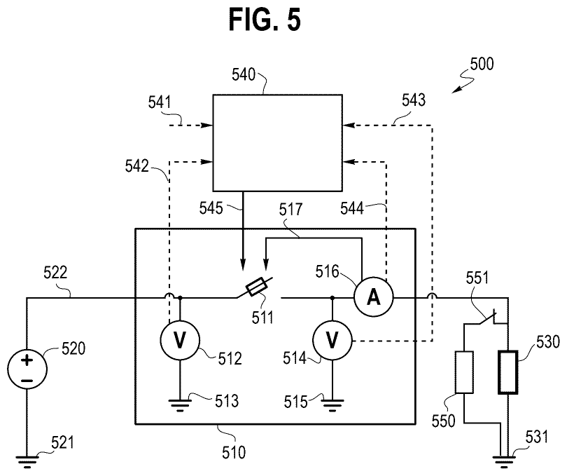

FIG. 5 and the following paragraphs illustrate one example implementation of an output channel of the power management system 100. It should be understood that this is merely one example and that other implementations can be used. Also, various components of the power management system 100 from FIG. 1 are not shown in FIG. 5 to simplify the illustration.

As shown in the diagram 500 in FIG. 5, the output channel 510 in is located between a power electrical source 520 grounded by ground 521 and a load (consumer) 530 grounded by ground 531. The power source 520 is configured to supply electric power to the load 530 via a power supply line 522. The output channel 510 acts as a switching unit disposed in the power supply line 522 to connect and disconnect the load 530 to and from the power source 520.

In the exemplary embodiment, the output channel 510 comprises a switch 511 to be opened or closed to connect and disconnect the load 530 to and from the power source 520. The output channel 510 further comprises two voltage measurement units 512, 514, each of which is ground by a respective ground 513, 515. However, in alternative embodiments, the system may comprise a common ground instead of separate grounds. Accordingly, any ground 513, 515, 521, 531 shown in the present embodiment may be alternatively provided by a common ground for all components or at least groups of components to be grounded. In a direction from the power source 520 to the load 530, one voltage measurement unit 512 is connected to the power supply line 522 upstream of the switch 511, and the other voltage measurement unit 514 is connected to the power supply line 522 downstream of the switch 511. In the same direction, the output channel 510 comprises a current measurement unit 516 downstream of the switch 511 (in the given exemplary embodiment downstream of the other voltage measurement unit 514).

The voltage measurement units 512, 514 provide a signal representative of the respective instantaneous voltage to a control unit 540 to control the switch 511 in dependence of set software limits. Specifically, the one voltage measurement unit 512 provides such signal via an upstream voltage signal line 542, and the other voltage measurement unit 514 provides such signal via a downstream voltage signal line 543. In the exemplary embodiment, the control unit 540 is separate from the output channel 510. However, in other embodiments, the control unit 540 may be also comprised by the output channel 510. Similarly, the current measurement unit 516 provides a signal representative of the instantaneous current via a current signal line 544 to the control unit 540. However, a signal representative of the instantaneous current is also forwarded from the current measurement unit 516 via a switching line 517 of the output channel 510 to control the switch 511 as per a set hardware current limit.

According to the above, the switch 511 is controlled in accordance with set software limits by the control unit 540 and a set hardware limit by the switching unit. In the control unit 540, the software limits are a software voltage limit and a software current limit representative of an overvoltage and overcurrent, respectively, to protect the consumer against a respective damage. A limit can also be placed on undervoltage. The setting of the software limits is executed via a command signal line 541, which is also capable of transmitting other control commands next to setting commands. The control commands may for example comprise the opening or closing of the switch 511 for other reasons than due to software limits. The control device is configured to compare the received voltage and current signals with the set software voltage limit and the set software current limit. Further, the control unit 540 is configured to consider a time condition in the event of the software voltage limit or the software current level is exceeded by one of the respectively received signals by the voltage measurement units 512, 514 and the current measurement unit 516. For example, a signal to open the switch 511 in response to an overcurrent to be transmitted via a switching line 545 of the control unit 540 is only transmitted after the instantaneous current exceeding the software current limit is detected over a predetermined period of time. Accordingly, short tolerable peaks in voltage and current may be acceptable to avoid a frequent switching. However, in other embodiments, a time condition may not be applied to the software current limit and/or the software voltage limit. The control device is further configured to transmit a signal to the output channel 510 to reopen the switch 511 after the instantaneous current signal and voltage signal fall again below the respective software limits, which may be also linked to a time condition.

As the output channel 510 and the switch 511, respectively, may provide a sensitivity to electric current different from the load 530 or should be independent thereof, the output channel 510 as such also controls the switch 511 in accordance with a hardware limit. Further, the control in accordance with the hardware limit allows the switch 511 to be opened immediately after a critical overload occurs with any further time conditions or the like. The hardware limit is also capable of protecting at least the switching unit, if the control unit 540 fails. The system further comprises a discharge device 550 connected in parallel to the load 530. Consequently, the discharge device 550 is connected to the power supply line 522 between the output channel 510 and the load 530 and to the ground 531. The discharge device 550 is configured to remove residual charges stored in the input capacitors of the load 530 when the load 530 is not supplied with electric power from the power source 520. Thus, a faster switch off of the load 530 may be achieved and an unwanted charging up of the capacitors may be prevented.

More information about embodiments that can be used for a vehicle switching unit can be found in PCT Publication No. WO 2023/213488, which is hereby incorporated by reference.

Also, additional embodiments that can be used with any of the embodiments presented herein are described in “Vehicle Power Management System and Method for Disconnecting/Resetting a Load and Using a Current Profile Based on Vehicle Information,” U.S. patent application Ser. No. ______ (attorney docket no. 123687.PI040US (2024P00032 US), which is being filed herewith and is hereby incorporated by reference herein.

### CONCLUSION

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A vehicle power management system comprising:
an input configured to receive current from a power source in a vehicle;
one or more outputs configured to couple with a respective one or more loads of the vehicle;
one or more switches associated with the respective one or more outputs, wherein each switch is configured to selectively open and close to selectively provide current received from the power source to that switch's associated output; and
circuitry configured to:
monitor a current draw from a load of the one or more loads;
determine if the monitored current draw matches an expected current draw; and
in response to determining that the monitored current draw does not match the expected current draw, flag the load is an unexpected load.

2. The vehicle power management system of claim 1, wherein an expected load comprises a load manufactured by an original equipment manufacturer (OEM) or its authorized supplier, and wherein an unexpected load comprises a load not manufactured by the OEM or its authorized supplier.

3. The vehicle power management system of claim 1, wherein an expected load comprises a dynamic load signature that may vary in time, phase, and/or use case.

4. The vehicle power management system of claim 1, wherein an expected load comprises a correct part, and wherein an unexpected load comprises an incorrect part.

5. The vehicle power management system of claim 1, wherein determining if the monitored current draw matches the expected current draw comprises comparing the monitored current draw to a baseline current draw.

6. The vehicle power management system of claim 1, wherein determining if the monitored current draw matches the expected current draw comprises comparing the monitored current draw to a library of expected current draws.

7. The vehicle power management system of claim 6, wherein the circuity is further configured to build the library of expected current draws.

8. The vehicle power management system of claim 6, wherein the library of expected current draws are programmed into the vehicle power management system by a manufacturer of the vehicle.

9. The vehicle power management system of claim 1, wherein flagging the load as an unexpected load comprises informing a controller associated with the load that the load is an unexpected load.

10. The vehicle power management system of claim 1, wherein flagging the load as an unexpected load comprises informing the OEM or fleet management that the load is an unexpected load.

11. The vehicle power management system of claim 1, wherein the circuitry is further configured to:
in response to determining that the monitored current draw does not match the expected current draw but matches a current draw associated with a known third-party load, reduce service time of the load.

12. The vehicle power management system of claim 1, wherein the circuitry is further configured to:
in response to determining that the monitored current draw does not match the expected current draw, limit a function of the load.

13. A method comprising:
performing in a vehicle:
creating a current profile for a load of the vehicle by monitoring current draws from the load and conditions of the vehicle when the current draws occurred;
monitoring a current draw from a replacement load;
determining if the monitored current draw of the replacement load matches the current profile; and
in response to determining that the monitored current draw does not match the current profile, flagging the replacement load as being unauthorized.

14. The method of claim 13, further comprising:
based on the current profile and a condition of the vehicle, determining whether a protection current limit should be changed; and
changing the current limit in response to determining that the protection current limit should be changed.

15. The method of claim 13, wherein an expected load comprises a dynamic load signature that may vary in time, phase, and/or use case.

16. The method of claim 13, further comprising:
determining whether an abnormality was detected; and
in response to determining that the abnormality was detected, logging the abnormality.

17. The method of claim 13, further comprising:
determining whether the vehicle is equipped with networking capability; and
in response to determining that the vehicle is equipped with networking capability, uploading the current profile to an external server for sharing with another vehicle.

18. The method of claim 13, wherein conditions of the vehicle comprise an air pressure, an ambient temperature, a value actuation, a system action, a system voltage, and/or diagnostic information.

19. The method of claim 13, wherein the current profile is built based on information about the vehicle.

20. A vehicle power management system comprising:
an input configured to receive power from a power source in a vehicle;
an output configured to couple with a load of the vehicle; and
circuitry configured to:
determine whether an expected current draw of the load has changed;
in response to determining that the expected current draw of the load has changed, update a current profile for the load;
monitor a current draw from the load;
determine if the monitored current draw matches the updated current profile; and
in response to determining that the monitored current draw does not match the updated current profile, flag the load as being unauthorized.

21. The vehicle power management system of claim 20, wherein the circuitry is further configured to:
inform an external entity of poor performance of the load in response to determining that the expected current draw of the load has increased.

22. The vehicle power management system of claim 20, wherein the circuitry is further configured to:
create a new current profile in response to determining that the expected current draw of the load has decreased.
